(19) United States
(12) Patent Application Publication
(10) Pub. No.: US 2026/0008273 A1
(43) Pub. Date: Jan. 8, 2026

(54) SYSTEMS AND METHODS FOR PRINTING UNOBSTRUCTED VEHICLE LABELS

(71) Applicants: Toyota Motor Engineering & Manufacturing North America , Inc., Plano, TX (US); Autoliv ASP, Inc., Auburn Hills, MI (US)

(72) Inventors: Ryan J. Spain, Ypsilanti, MI (US); Scott Downard, Clearfield, UT (US)

(73) Assignees: Toyota Motor Engineering & Manufacturing North America , Inc., Plano, TX (US); Toyota Jidosha Kabushiki Kaisha, Aichi- Ken (JP); Autoliv ASP, Inc., Auburn Hills, MI (US)

(21) Appl. No.: 18/763,506

(22) Filed: Jul. 3, 2024

(51) Int. Cl. B41J 3/407; B41J 3/01; B65C 9/40

(52) U.S. Cl. CPC B41J 3/4075; B41J 3/01; B65C 9/40

(57) ABSTRACT

Systems described herein relate to printing vehicle component labels such that other vehicle components do not obscure information thereon upon installation into a vehicle. In one embodiment, a system includes a processor and a memory storing machine-readable instructions. The machine-readable instructions, when executed by the processor, cause the processor to 1) identify a portion of a label that, when affixed to a first vehicle component, is blocked by a second vehicle component upon assembly into a vehicle and 2) alter the label so target printed information of the label is arranged on an unobscured region of the label where the target printed information, when affixed to the first vehicle component, is not obscured by the second vehicle component. The machine-readable instructions, when executed by the processor, also cause the processor to print the label with the target printed information in the unobscured region.

### TECHNICAL FIELD

The subject matter described herein relates, in general, to printing labels for vehicle components and, more particularly, to printing labels such that other vehicle components do not obscure certain label content upon assembly into a vehicle.

### BACKGROUND

Vehicles are complex machines made up of a variety of components. The diversity of assembled components and precise installation procedures for the varying components can present fabrication and assembly difficulties. These difficulties may be remedied by placing informational labels that convey information, such as instructions or a machine-readable code that directs an electronic device to a resource with instructions for installation on the component. Component labels may be placed on components for other reasons as well. For example, some labels may include tracking information for an associated component. This tracking information may be helpful throughout the vehicle's life, for example, to issue recalls associated with the component and/or to determine the manufacturing history of the component.

As a particular example, an airbag may be housed within a casing. This airbag assembly is installed into the vehicle. When deployed, the airbag is inflated and ejected from the casing to protect passengers during a collision. In this example, an information and/or instructional label may be attached to the casing for a variety of reasons, such as providing installation instructions to a technician and/or providing tracking information on the airbag, which tracking information may be used to identify malfunctioning airbags and identify a source of the malfunction. While particular reference is made to particular label information, a variety of other types of information may be printed on a label which is affixed to a vehicle component.

### SUMMARY

In one embodiment, example systems relate to a manner of improving label visibility on components installed within a vehicle.

In one embodiment, a label printing system for positioning label content on a vehicle component so as to be unobstructed by other vehicle components when installed into a vehicle is disclosed. The label printing system includes one or more processors and a memory communicably coupled to the one or more processors. The memory stores instructions that, when executed by the one or more processors, cause the one or more processors to 1) identify a portion of a label that, when affixed to a first vehicle component, is blocked by a second vehicle component upon assembly into a vehicle and 2) alter the label so target printed information of the label is arranged on an unobscured region of the label where the target printed information, when affixed to the first vehicle component, is not obscured by the second vehicle component. The memory also stores instructions that, when executed by the one or more processors, causes the one or more processors to print the label with the target printed information in the unobscured region.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1C illustrate the alteration of a label to avoid obscured target printed content on a component of an assembled vehicle.

FIG. 2 illustrates one embodiment of a label printing system that is associated with positioning target printed content on a vehicle component to avoid obstruction by another component in an assembled vehicle.

FIG. 3 illustrates a flowchart for one embodiment of a method that is associated with positioning target printed content on a vehicle component to avoid obstruction in an assembled vehicle.

### DETAILED DESCRIPTION

Systems and methods associated with improving label layout, specifically by preventing the blockage of certain label information by a second vehicle component when assembled into a vehicle, are disclosed herein. As previously described, labels may be affixed to vehicle components to convey various information to technicians, end users, or any other individual interacting with the vehicle during its life (i.e., through manufacturing and intended use). However, it may be the case that another component obscures the label once the labeled component and the other component are installed in the vehicle. For example, an airbag casing/module may include a label with a machine-readable code (e.g., barcode or quick response (QR) code) printed thereon. The machine-readable code may reference a database location where information such as installation instructions, expected life of the product, manufacturing history, and/or a serial number for the product, among other information, may be located. The technician may then scan the machine-readable code to view the information. As another example, quality assurance personnel may scan the machine-readable code to verify the airbag's compliance with manufacturing criteria.

However, upon assembly into a vehicle, the machine-readable code may be blocked by another installed component. As a particular example, a passenger-side airbag may be installed into a dashboard from a rearward direction (i.e., the “B” side that is not facing the interior portion of the cabin). As such, the passenger side airbag may be positioned below a glove box or fascia panel of the passenger side dashboard. In this arrangement, the glove box or fascia panel may block the portion of the airbag module where the label is placed. As such, the information on or referenced by the label may be inaccessible. Moreover, moving the label to another location on the first component may be undesirable as manufacturing equipment may be calibrated with the label placed in a particular location, and adjusting that location may trigger changes to the manufacturing operation. Moreover, the unstructured placement of component labels may result in imprecise and inaccurately placed labels, which may similarly be unreadable by a scanner, downstream manufacturing technician, or end user.

Accordingly, the present label printing system improves the visibility of label content (e.g., warning and/or tracking information and/or machine-readable code that references the warning and/or tracking information) on an installed vehicle component such as a vehicle airbag module. For example, blank space may be added to a portion of the label, thus shifting the position of the target printed content to a portion of the label that is unobstructed when assembled in the vehicle.

In this way, the disclosed systems, methods, and other embodiments improve label efficiency by improving the label's visibility in an assembled vehicle, thus ensuring the information contained thereon is accessible to a technician, end-user, or any other individual. Moreover, the disclosed systems, methods, and other embodiments may maintain, and thus not change, the manufacturing operations of the vehicle component (e.g., airbag module) and its assembly into a vehicle as the disclosed systems, methods, and other embodiments may allow the label to be placed at the same label location. Thus, the cost impact of providing the increased visibility is reduced.

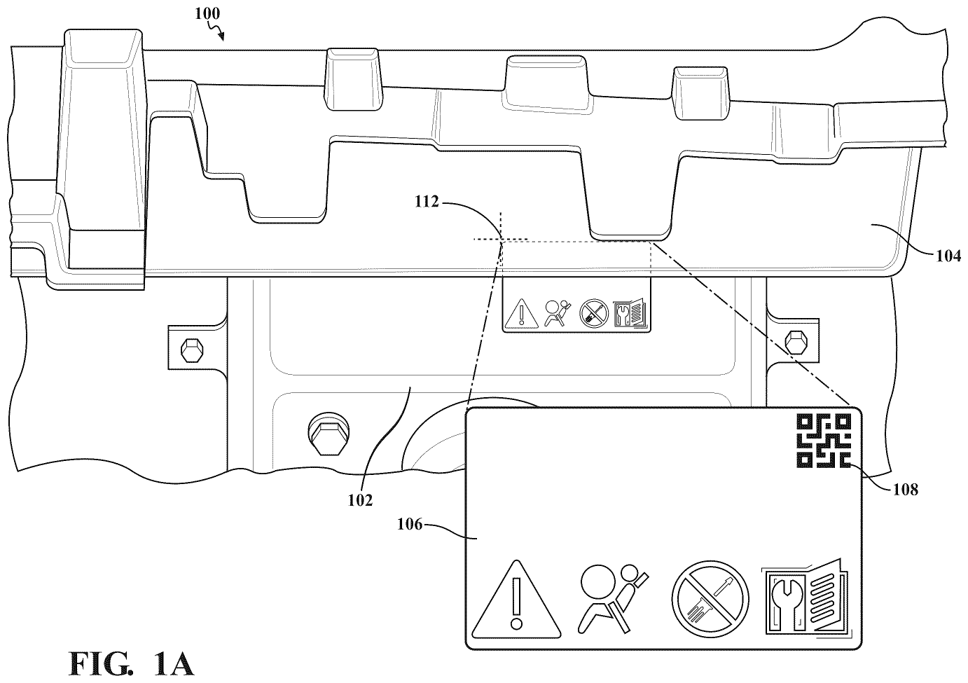

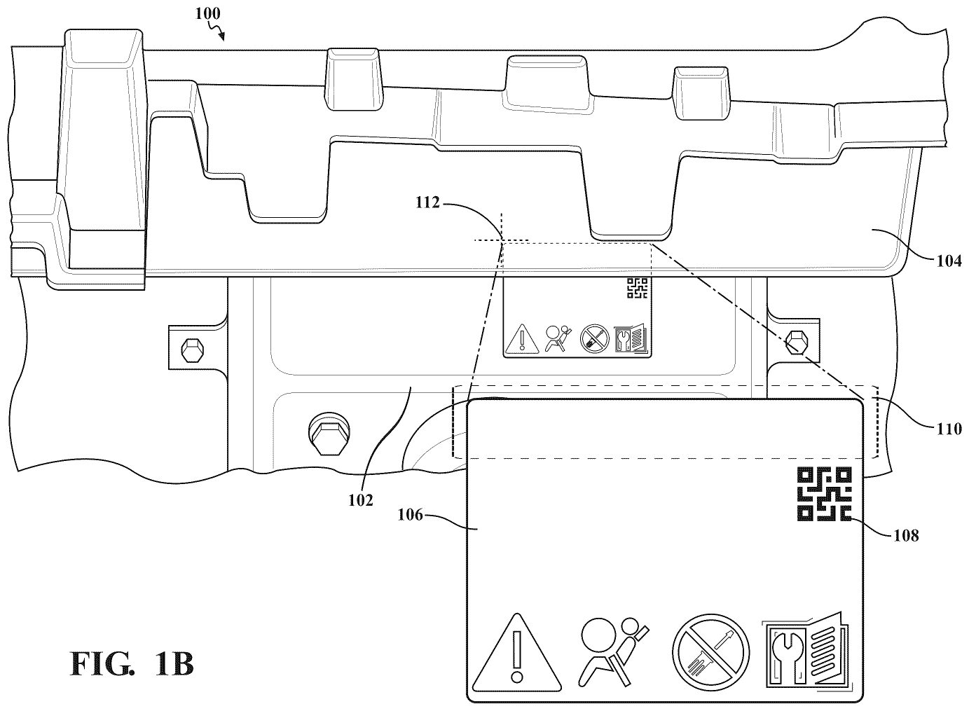

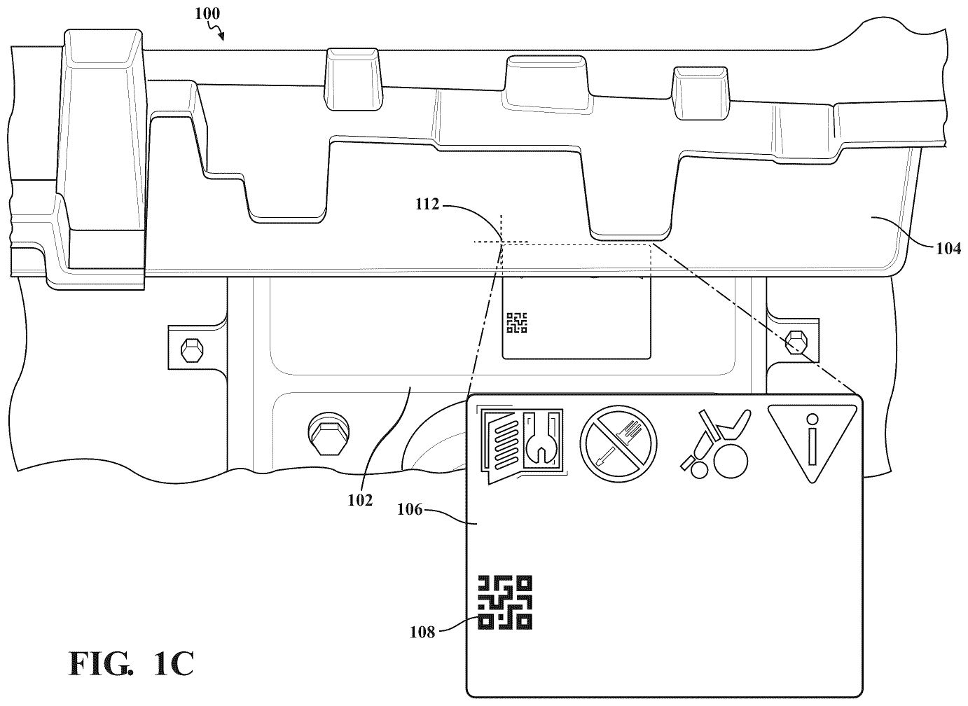

Turning now to the figures, FIGS. 1A-1C illustrate the alteration of a label 106 to avoid obscured target printed content in an assembled vehicle. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, a label 106 may be adhered to a vehicle component. As a specific example, the label 106, which may contain various printed information as described above, may be attached to an airbag container to be installed in a dashboard 100 of a vehicle. The printed information may take various forms, including a machine-readable code 108 that is scannable by a scanning device. It may be desirable that at least portions of the label 106 are unobstructed so that the target information (e.g., the machine-readable code 108) may be scanned and a technician may access the information associated with the machine-readable code 108. When the label 106 is positioned on a first vehicle component 102 (e.g., an airbag container), it may be the case that the machine-readable code 108 on the label 106 is fully visible and thus readable by a scanning device. However, upon assembly into the dashboard 100 with other components, such as a second vehicle component 104, the label 106, and the machine-readable code 108 printed thereon, may become obscured. That is, installation of the first vehicle component 102 (e.g., the airbag container) into an assembly such as a vehicle dashboard 100 that receives multiple other components, such as the second vehicle component 104, may result in obstruction of a portion of the label 106 (indicated in dashed lines in FIG. 1A-1C) impeding some or all, of the information contained on the label 106 from being read, scanned, or otherwise accessed. It should be noted that the obstruction may result even when the second vehicle component 104 does not contact the first vehicle component 102. That is, the second vehicle component 104 may obstruct the label 106 by covering the label 106 without physically contacting the physical label 106 and/or the first vehicle component 102. While FIG. 1A depicts specific content on the label 106, the contents of the label 106 are not limited and can include any pictorial, graphical, textual, or coded information.

Accordingly, as depicted in FIG. 1B, the label 106 may be altered to position the target printed information, specifically the machine-readable code 108, in an unobstructed region of the label 106. Such alterations may take a variety of forms. For example, a label printing system may add blank space 110 to a portion of the label 106 that falls under the obscured region (i.e., the portion of the label 106 that is obscured by the second vehicle component 104). Doing so shifts the target printed information down such that it is no longer in the obscured portion but is instead found on an unobscured portion of the label 106 and thus accessible to the technician for reading, scanning, or otherwise accessing.

In an example, the label 106 may be affixed to the first vehicle component 102 at a predetermined location 112, which predetermined location 112 may be identified and defined by a particular corner of the label 106. In an example, the predetermined location 112 may be identified in the manufacturing process of the first vehicle component 102, for example via an illuminating laser, so that a technician may accurately place the label 106 at the same location on each first vehicle component 102 that is manufactured. Were the label 106 simply moved to expose the target printed information, rather than adjusted with additional blank space 110, the manufacturing operation may need to be adjusted (e.g., the label positioning laser may need to be re-calibrated) to ensure repeatable and accurately placed labels 106 on different instances of the first vehicle component 102 to be installed in different vehicles.

Moreover, it may be that the predetermined location 112 is selected based on the first vehicle component 102 having a particular surface, orientation, or purpose that suggests a particular location is more desirable for the label 106. For example, the first vehicle component 102 may have physical contours, surfaces, or installation options that mandate a particular location for the label 106. As such, in the example depicted in FIG. 1B, the label printing system may identify a portion of the label 106 that is blocked when the label 106 is placed at a predetermined location 112 on the first vehicle component 102. The label 106 is affixed to the first vehicle component 102 at the predetermined location 112. As depicted in FIG. 1B, in an example the size and shape of the blank space 110 matches the size and shape of the portion of the label 106 that is blocked by the second vehicle component 104.

In an example, adding blank space 110 to the label 106 may result in an adjustment to the size of the label 106. That is, the label 106 is bigger because of the additional blank space 110 added to the label 106. The amount of blank space 110 added to the label may vary based on a number of criteria, such as the vehicle, the component, and the degree of obstruction. In an example, the amount of added blank space 110 may be between 5 and 15 millimeters (mm), for example, 10 mm.

FIG. 1C depicts another alteration that may be made to the label 106. In this example, to further alter the position of the target printed information that is obscured (i.e., the machine-readable code 108), the target printed information is inverted on the label 106. As depicted in FIG. 1C, this results in the machine-readable code 108, or other target printed information, being accessible by the scanning device. In other words, as depicted in FIGS. 1B and 1C, there are various alterations the label printing system may make to the label 106 to ensure that certain content is accessible to a scanning device.

In other examples, the label 106 may be adjusted in other ways. For example, the label printing system may adjust the size of the printed information on the label 106. However, in some examples, adjusting the size of the printed information may be undesirable. For example, industry guidelines, regulations, and/or best practices may dictate a specific size and/or font for information on a label 106. As such, resizing the printed information, including the target printed information, may result in information that does not comply with these guidelines, regulations, and/or best practices. Moreover, as described above, simply moving the label 106 on the first vehicle component 102 may be undesirable due to the alterations it may trigger in the first vehicle component 102 manufacturing operation and the associated costs. Accordingly, the label printing system described herein facilitates visibility and accessibility of the target printed information without altering the manufacturing processes of the vehicle components while adhering to industry or government guidelines, regulations, and/or best practices.

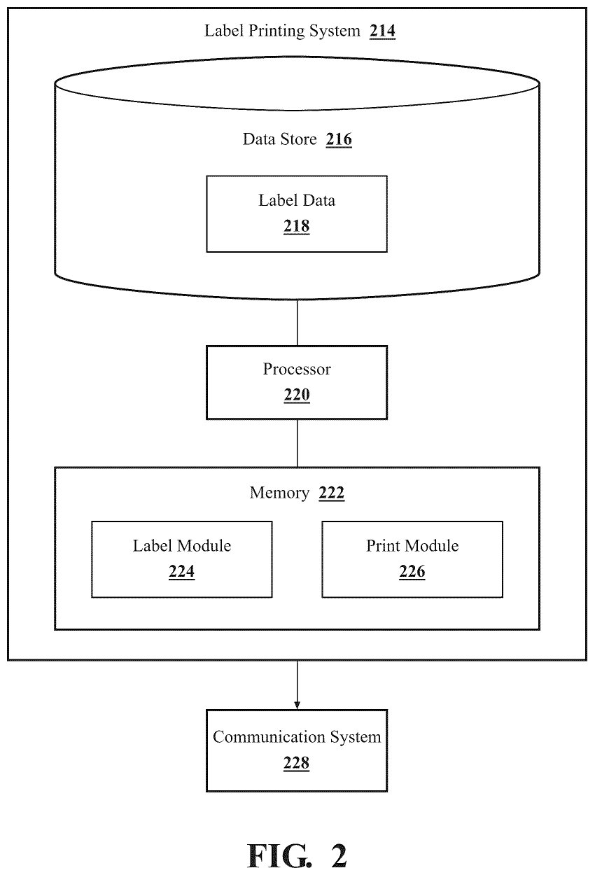

FIG. 2 illustrates one embodiment of a label printing system 214 that is associated with positioning target printed information on a vehicle component to avoid obstruction in an assembled vehicle. The label printing system 214 includes one or more processors 220. In one or more arrangements, the processor(s) 220 may be a primary/centralized processor or may be representative of many distributed processing units. For instance, the processor(s) 220 can be an electronic control unit (ECU). Alternatively, or additionally, the processors include a central processing unit (CPU), a graphics processing unit (GPU), an application-specific integrated circuit (ASIC), a microcontroller, a system on a chip (SoC), and/or other electronic processing units that support the operation of the label printing system 214.

The label printing system 214 can include one or more data stores 216 for storing one or more types of data. The data store 216 is, in one embodiment, an electronic data structure stored in the memory 222 or another data storage device and that is configured with routines that can be executed by the processor 220 for analyzing stored data, providing stored data, organizing stored data, and so on. Thus, in one embodiment, the data store 216 stores data used by the modules 224 and 226 in executing various functions. The data store 216 can be comprised of volatile and/or non-volatile memory. Examples of memory that may form the data store 216 include Random Access Memory (RAM), flash memory, Read Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, solid-state drivers (SSDs), and/or other non-transitory electronic storage medium. In one configuration, the data store 216 is a component of the processor(s) 220. In general, the data store 216 is operatively connected to the processor(s) 220 for use thereby. The term “operatively connected,” as used throughout this description, can include direct or indirect connections, including connections without direct physical contact.

As described above, the label printing system 214 identifies potential obstructions that may block target printed information from being read by a technician, end user, or other individual or from being scanned by a scanning device. As such, the data store 216 includes label data 218 that allows for positioning the target printed information on the label 106 in an unobstructed fashion. Specifically, the label data 218 may include the content that is to be printed on the label 106. As described above, text, graphics, icons, codes, or other content may be physically printed onto a label 106. Through a graphical manipulation application-based label module 224, a user can determine where certain information should be placed on the label 106. In other words, the label data 218 may include any textual or graphical content to be placed on the label 106.

Still further, the label data 218 may include information through which an obstruction of target printed information by another vehicle component may be identified. For example, the label data 218 may include images of the first vehicle component 102 and/or the second vehicle component 104 installed in the vehicle. From such, relying on user input or automatically, the label module 224 may determine that the second vehicle component 104 at least partially obscures the target printed information to a degree to which it is difficult for a user or a scanning device to access. In another example, the label data 218 includes digital representations, such as three-dimensional (3D) models of the assembled vehicle or a portion of the assembled vehicle. Similarly, either through manual input or automated image analysis, the label module 224 may identify an obstruction of the target printed information by the second vehicle component 104. In another example, the label data 218 may include a service or maintenance record through which the obstruction may be identified. That is, during the assembly of a previous vehicle, a team member may identify and note an obstruction and enter such into a service or maintenance log. In any case, the label data 218, in addition to including the information to be contained on the label 106, may also include data by which an obstruction may be identified.

In one embodiment, the label printing system 214 includes a memory 222 that stores a label module 224 and a print module 226. The memory 222 is a random-access memory (RAM), read-only memory (ROM), a hard-disk drive, a flash memory, or another suitable memory for storing the modules 224 and 226. In at least one arrangement, the modules 224 and 226 are implemented as non-transitory computer-readable instructions that, when executed by the processor 220, implement one or more of the various functions described herein. In various arrangements, one or more of the modules 224 and 226 are a component of the processor(s) 220, or one or more of the modules 224 and 226 are executed on and/or distributed among other processing systems to which the processor(s) 220 is operatively connected. Alternatively, or in addition, the one or more modules 224 and 226 are implemented, at least partially, within hardware. For example, the one or more modules 224 and 226 may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules 224 and 226 can be distributed among a plurality of the modules described herein. In one or more arrangements, two or more of the modules 224 and 226 described herein can be combined into a single module.

The label printing system 214 includes a label module 224 that, in one embodiment, includes instructions that cause the processor 220 to 1) identify a portion of the label 106 that, when affixed to a first vehicle component 102, is blocked by a second vehicle component 104 upon assembly into a vehicle and 2) alter the label 106 such that target printed information (e.g., the machine-readable code 108) of the label 106 is arranged on an unobscured region of the label 106. The target printed information, when in the unobscured region and when the label 106 is affixed to the first vehicle component 102, is not obscured by the second vehicle component 104.

As described above, there may be various ways to identify a potential obstruction of target printed information on a label 106 by a second vehicle component 104. Examples include image analysis, 3D model analysis, maintenance, and/or service log analysis. Accordingly, in this example, the label module 224 generally includes instructions that cause the processor 220 to identify those portions of the label 106 blocked by the second vehicle component 104. Such analysis may be manual or automatic. For example, a user or an automated system may perform image analysis (e.g., pixel analysis) to determine which portions of a first vehicle component 102 are obscured by a second vehicle component 104. Similarly, a user or an automated system may analyze a 3D model of a vehicle or a portion of a vehicle to determine portions of a second vehicle component 104 that overlap a first vehicle component 102. The overlapped portion of the first vehicle component 102 may be identified as the portion blocked by a second vehicle component 104.

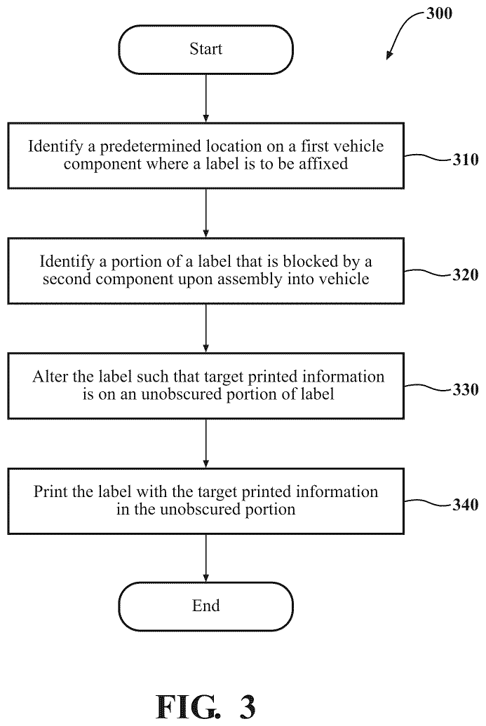

The label module 224 may also include instructions that cause the processor 220 to generate a digital representation of the label 106. That is, the label module 224 may execute a graphic processing application wherein a visual representation of the label 106 and the contents to be placed thereon may be manipulated. Through this label module 224, a user may adjust any number of characteristics of the label 106 and/or the printed information (including the target printed information that is to be unobscured). For example, the user may increase the size of the label 106, with a portion of the increased-size label 106 being reserved for blank space 110. As another example, the user may alter the orientation and placement of the printed information. For example, a user may rotate features and/or change the size of the different printed information objects. Such adjustments are made to ensure that the target printed information on the label 106 affixed to the first vehicle component 102 is unobscured when assembled into a vehicle alongside the second vehicle component 104. While particular adjustments and manipulations are discussed herein, a variety of adjustments, both to the label 106 and the content printed thereon, may be made per the principles described herein. These changes may be facilitated by a user interface through which a user can manipulate the virtual representation of the label 106 and/or its contents. Additional detail regarding the alterations that may be made are provided below in connection with FIG. 3.

In an example, the obstructed region of the label 106 may be visually indicated or highlighted to aid a technician in positioning target printed information in areas that are sure to be visible once assembled. In a specific example, in addition to highlighting the obstructed region, the label module 224 may prevent printed content from being placed in a region visually indicated or otherwise indicated as being an obstructed region. As an example, the graphic processing application may prevent the placement of certain content (i.e., target printed content) from being virtually placed in the obstructed region and/or may provide a warning to a user that the desired placement of the target content at a selected location may result in obscuring of that content.

The label printing system 214 includes a print module 226 that, in one embodiment, includes instructions that cause the processor 220 to print the label 106 with the target printed information in the unobscured region. That is, the target printed information is printed (or etched, or otherwise formed) onto a substrate to be attached to the first vehicle component 102 in such a fashion as to not be blocked by the second vehicle component 104 upon installation. The label 106 may be printed or formed in any number of fashions, including printing or etching, to name a few. As provided for herein, the label printing system 214 functions in cooperation with a communication system 228. Via the communication system 228, the print module 226 communicates with a printing device, such as a printer or etching device, to physically form the label 106 with the target printed information.

In one embodiment, the communication system 228 communicates according to one or more communication standards. For example, the communication system 228 can include multiple different antennas/transceivers and/or other hardware elements for communicating at different frequencies and according to respective protocols. The communication system 228, in one arrangement, communicates via a communication protocol, such as a WiFi, dedicated short-range communication (DSRC), or another suitable protocol. In any case, the label printing system 214 facilitates the alteration of the position of target printed content to ensure that such is not obscured by other vehicle components when assembled into a vehicle. Such alteration is triggered by an identified potential obstruction via image, model, or log analysis. Thus, labels 106 are prepared with relevant information contained thereon, which labels 106 are readable/scannable by a team member, end user, or scanning device.

Additional aspects of improving target printed content visibility will be discussed in relation to FIG. 3. FIG. 3 illustrates a flowchart of a method 300 that is associated with improving the visibility of target printed information on labels 106 affixed to vehicle components. Method 300 will be discussed from the perspective of the label printing system 214 of FIG. 2. While method 300 is discussed in combination with the label printing system 214, it should be appreciated that the method 300 is not limited to being implemented within the label printing system 214 but is instead one example of a system that may implement the method 300.

At 310, the label printing system 214 identifies a predetermined location 112 where a label is to be affixed on a first vehicle component 102. As described above, for various reasons, it may be that a label 106 is targeted for affixation to the first vehicle component 102 at a predetermined location 112. This may be based on the contours, shape, and/or size of the first vehicle component 102. Placing the label 106 at a predetermined location 112, rather than any random position, ensures the information thereon is presented in a controlled fashion. Were a predetermined location 112 not established for placement of the label 106, the label 106 may be placed at any location on the first vehicle component 102, including those where it is not accessible and readily viewed by a technician. For example, when affixing the label 106 to the first vehicle component 102, this predetermined location 112 may be visually identified, for example, by projecting a light onto the first vehicle component 102.

At 320, the label printing system 214 identifies a portion of the label 106 on the first vehicle component 102 blocked by the second vehicle component 104 upon installation of the first vehicle component 102 and the second vehicle component 104 into the vehicle. In an example, the machine-readable instructions may include instructions that cause the processor 220 to identify an arrangement of the first vehicle component 102 relative to the second vehicle component. As described above, this may be done in any number of ways, including analysis of captured images of the first and second vehicle components, analysis of a 3D model of the vehicle, or portion of the vehicle, with the first and second components installed therein, and/or an analysis of the maintenance/service logs. This blocked region may be identified in the graphic processing application used to generate and configure the label 106 that will ultimately be printed. In the example where the label 106 is to be placed at a predetermined location 112 on the first vehicle component 102, the machine-readable instructions include instructions that cause the processor 220 to identify the portion of the label 106 that is blocked when the label 106 is placed at a predetermined location 112 on the first vehicle component 102. In an example, the identification of the blocked portion may be visually indicated to the user of the label printing system 214, for example, via digital highlighting, which indicates the portion of the label 106 that will be blocked. As described above, the printed label, with the target printed information in the unobscured region, is affixed to the first vehicle component 102 at the predetermined location 112.

At 330, the label printing system 214, particularly the label module 224, alters the label 106 to arrange the target printed information in the unobscured region. As described above, such alteration may take a variety of forms and may be executed within a graphics altering/processing application. In one example, as depicted in FIG. 1B, the machine-readable instructions include instructions that cause the processor 220 to add blank space 110 to the portion of the label 106 blocked by the second vehicle component 104. Such addition may be based on user input or an analysis of the arrangement of the first vehicle component 102 and the second vehicle component 104. For example, a user may manipulate a cursor of a computing device to increase the size of the label 106 or enter the dimensions of the label 106. As depicted in FIGS. 1A and 1B, doing so shifts the content to a portion of the label 106 that is not blocked when the first and second vehicle components are installed into the vehicle dashboard 100. In some examples, adding blank space 110 to the label 106 may result in a bigger label 106. Accordingly, the machine-readable instructions include instructions to adjust a size of the label 106, for example, to account for the addition of the target printed information shifting blank space 110. Note that as depicted in FIGS. 1A and 1B, adding the blank space 110 does not change the predetermined location 112 where the label 106 is affixed to the first vehicle component 102, yet makes the target printed information (e.g., the machine-readable code 108) visible notwithstanding the overlapping of the first vehicle component 102 by the second vehicle component 104.

In an example, altering the label 106 includes inverting the target printed information. That is, as depicted in FIG. 1C, the machine-readable instructions include instructions that, when executed by the processor 220, cause the processor 220 to invert the target printed information on the label 106. Doing so may further increase the visibility of the target printed information by increasing the distance between the target printed information and the overlap region between the first vehicle component 102 and the second vehicle component 104. While particular reference is made to particular alterations to the label 106, other alterations may also be made. For example, the label module 224 may include instructions that, when executed by the processor 220, cause the processor 220 to adjust the size of the target printed information on the label 106.

Whatever alterations are made, at 340, the label printing system 214, particularly the print module 226, prints the label 106 with the target printed information in the unobscured portion. That is, the print module 226 prints the label 106 with the target printed information in the region identified by the label module 226, either automatically or based on user input, that is not obscured when both the first vehicle component 102 and the second vehicle component 104 are installed in the vehicle dashboard 100. As such, the present label printing system 214 of the present specification allows for the placement of target printed information (such as particularly relevant safety information or tracking information or information that is to be scanned by a scanning device) on a region of a vehicle component (such as airbag container), where the target printed information will be visible/scannable, notwithstanding any overlap between the component (i.e., the airbag container) and other components that are installed in the vehicle.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1A-3, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
identify a portion of a label that, when affixed to a first vehicle component, is blocked by a second vehicle component upon assembly into a vehicle;
alter the label so target printed information of the label is arranged on an unobscured region of the label where the target printed information, when affixed to the first vehicle component, is not obscured by the second vehicle component; and
print the label with the target printed information in the unobscured region.

2. The system of claim 1, wherein the first vehicle component is an airbag container.

3. The system of claim 1, wherein the machine-readable instruction that, when executed by the processor, causes the processor to identify the portion of the label that is blocked by the second vehicle component comprises a machine-readable instruction that, when executed by the processor, causes the processor to identify an arrangement of the first vehicle component relative to the second vehicle component.

4. The system of claim 1, wherein:
the machine-readable instruction that, when executed by the processor, causes the processor to identify the portion of the label that is blocked by the second vehicle component comprises a machine-readable instruction that, when executed by the processor, causes the processor to identify the portion of the label that is blocked when the label is placed at a predetermined location on the first vehicle component; and
a printed label with the target printed information in the unobscured region is affixed to the first vehicle component at the predetermined location.

5. The system of claim 1, wherein the machine-readable instruction that, when executed by the processor, causes the processor to alter the label so the target printed information of the label is arranged on the unobscured region of the label comprises a machine-readable instruction that, when executed by the processor, causes the processor to add blank space to the portion of the label that is blocked by the second vehicle component.

6. The system of claim 5, wherein a size and shape of the blank space match a size and shape of the portion of the label that is blocked by the second vehicle component.

7. The system of claim 1, wherein the machine-readable instruction that, when executed by the processor, causes the processor to alter the label so the target printed information of the label is arranged on the unobscured region of the label comprises a machine-readable instruction that, when executed by the processor, causes the processor to invert the target printed information on the label.

8. The system of claim 1, wherein the machine-readable instruction that, when executed by the processor, causes the processor to alter the label so the target printed information of the label is arranged on the unobscured region of the label comprises a machine-readable instruction that, when executed by the processor, causes the processor to adjust a size of the label.

9. The system of claim 1, wherein the machine-readable instruction that, when executed by the processor, causes the processor to alter the label so the target printed information of the label is arranged on the unobscured region of the label comprises a machine-readable instruction that, when executed by the processor, causes the processor to adjust a size of the target printed information on the label.

10. The system of claim 1, wherein the target printed information comprises a machine-readable code scannable by a scanning device.
